(19) United States
(12) Patent Application Publication
(10) Pub. No.: US 2025/0184598 A1
(43) Pub. Date: Jun. 5, 2025

(54) IMAGE CAPTURING APPARATUS

(71) Applicant: CANON KABUSHIKI KAISHA, Tokyo (JP)

(72) Inventor: SHIGEYOSHI ITO, Tokyo (JP)

(21) Appl. No.: 18/947,275

(22) Filed: Nov. 14, 2024

(30) Foreign Application Priority Data
Nov. 30, 2023 (JP) 2023-203122

(51) Int. Cl. H04N 23/63; H04N 23/61; H04N 23/745; H04N 25/443; H04N 25/78

(52) U.S. Cl. CPC H04N 23/633; H04N 23/61; H04N 23/745; H04N 25/443; H04N 25/78

(57) ABSTRACT

An image capturing apparatus includes an image sensor including a pixel portion, a readout portion configured to read out a first image signal and a second image signal from the pixel portion, the second image signal being lower in resolution than the first image signal, an image processor configured to generate a third image signal from the first image signal, the third image signal being lower in resolution than the first image signal, a first output portion configured to output the first image signal, and a second output portion configured to output the second image signal or the third image signal, a first integrated circuit configured to process the first image signal output, and a second integrated circuit configured to process the second image signal or the third image signal output.

### BACKGROUND OF THE INVENTION

### Field of the Invention

The present invention relates to an image capturing apparatus.

### Description of the Related Art

In general, digital cameras and electronic devices equipped with a camera function often have a “live-view function (LV function)”. The “live-view function” is a function that displays shot images on a display unit in real time while shooting moving images or the like. A user can adjust a shooting range of still image shooting and moving image shooting while checking the moving images displayed by the live-view function.

In order for the user to perform shooting intended by the user, it is crucial that the aforementioned adjustment of the shooting range be easy. For example, in a case where a still image is shot during shooting of moving images, moving images cannot be obtained in a frame in which the still image has been shot. In this case, as images to be displayed as a live view cannot be obtained, ease of the adjustment of the shooting range is impaired. In order to make the adjustment of the shooting range easy, it is crucial to prevent a lack of frames of a live view even when a still image is shot. For this reason, it is known that processing different from processing for live-view images is executed for a still image.

For example, Japanese Patent No. 6757199 discloses an image sensor that has a first mode in which image data that has been read out from a pixel portion is transferred to a memory built in the image sensor, and a second transfer mode in which the image data is transferred to the outside of the image sensor.

Japanese Patent Laid-Open No. 2023-106041 discloses a method of data processing for a case where a plurality of data pieces have been read out inside an image sensor. Specifically, it describes a method in which still image data from a pixel portion is output after being reduced to a live-view image by a conversion circuit inside the image sensor, and in which when live-view image data has been read out from the pixel portion, the live-view image data is output without being reduced.

However, according to the technique disclosed in the aforementioned Japanese Patent No. 6757199, image data with a large data amount, such as a still image, cannot be used in live-view display, which causes a lack of a display frame of a live view.

Also, although Japanese Patent Laid-Open No. 2023-106041 discloses processing of data inside the image sensor, it does not provide a clear description on a processing method related to signal processing circuits connected to the image sensor. Furthermore, it does not provide a clear description on a method of configuring appropriate output interfaces that respectively correspond to a still image and a live-view image, either.

### SUMMARY OF THE INVENTION

The present invention has been made in view of the above-described problems, and provides an image capturing apparatus capable of preventing a lack of live-view images in a case where a user performs shooting while looking at live-view images.

According to an aspect of the present invention, there is provided an image capturing apparatus, comprising: an image sensor including a pixel portion in which a plurality of pixels are arrayed in a matrix, a readout portion configured to read out a first image signal and a second image signal from the pixel portion, the second image signal being lower in resolution than the first image signal, an image processor configured to generate a third image signal from the first image signal, the third image signal being lower in resolution than the first image signal, a first output portion configured to output the first image signal, and a second output portion configured to output the second image signal or the third image signal; a first integrated circuit configured to process the first image signal output from the first output portion of the image sensor; and a second integrated circuit configured to process the second image signal or the third image signal output from the second output portion of the image sensor.

Further features of the present invention will become apparent from the following description of exemplary embodiments with reference to the attached drawings.

### BRIEF DESCRIPTION OF THE DRAWINGS

FIG. 1 is a block diagram showing a configuration of an image capturing apparatus according to a first embodiment of the present invention.

FIGS. 2A and 2B are diagrams showing a configuration of an image sensor.

FIGS. 3A and 3B are diagrams showing a stacking structure of the image sensor.

FIGS. 4A and 4B are diagrams showing data paths of still images and LV images.

FIG. 5 is a timing chart showing the operations of the image sensor according to the first embodiment.

FIG. 6 is a timing chart showing the operations of the image sensor according to a second embodiment.

FIG. 7 is a timing chart showing the operations of the image sensor according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

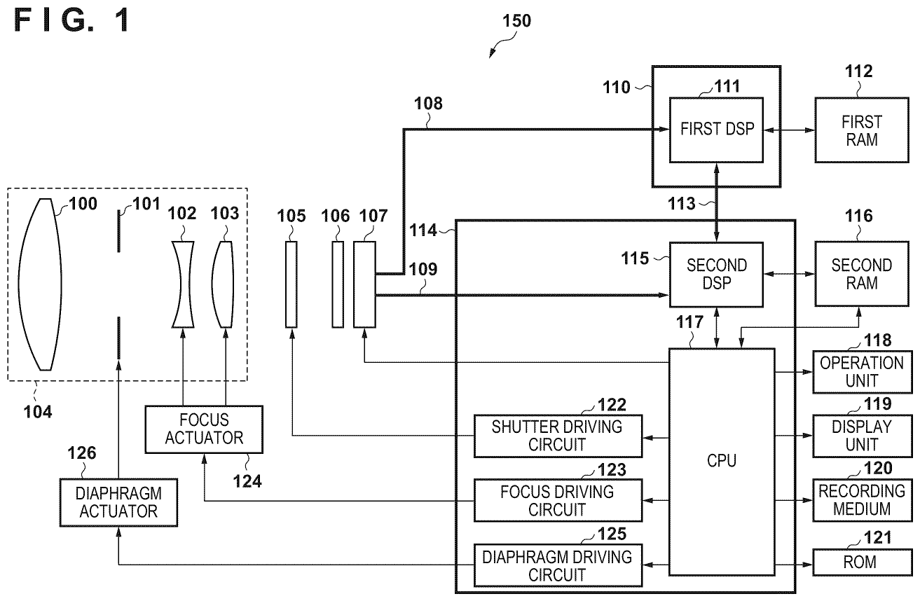

FIG. 1 is a block diagram showing a configuration of an image capturing apparatus according to a first embodiment of the present invention. As shown in FIG. 1, an image capturing apparatus 150 includes an image capturing optical system 104. The image capturing optical system 104 includes a first lens 100, a diaphragm 101, a second lens 102, and a third lens 103. The first lens 100 is arranged at the front end of the image capturing optical system 104. The diaphragm 101 adjusts the amount of light at the time of shooting by adjusting the aperture diameter thereof. The aperture diameter of the diaphragm 101 is adjusted by driving a diaphragm actuator 126. Driving a later-described focus actuator 124 causes the second lens 102 and the third lens 103 to advance and recede in the optical axis direction, thereby adjusting a focal point of the image capturing optical system 104.

A focal plane shutter 105, an optical low-pass filter 106, and an image sensor 107 are arranged in this order behind the image capturing optical system 104. The focal plane shutter 105 has a function of adjusting an exposure time period at the time of still image shooting. The optical low-pass filter 106 has a function of reducing false color and moiré in a shot image. The image sensor 107 converts an optical image of a subject formed by the image capturing optical system 104 into electrical signals.

The image capturing apparatus 150 includes a first integrated circuit 110 and a second integrated circuit 114. The first integrated circuit 110 includes a first digital signal processor (DSP) 111.

The first DSP 111 is connected to the image sensor 107 via a first interface (IF) 108, which acts as a first output portion, receives image data transmitted from the image sensor 107, and executes image processing. Examples of image processing executed by the first DSP 111 include processing for correcting still image data and the like.

A first RAM 112 is connected to the first integrated circuit 110, and stores image data processed by the first DSP 111. Note that although the first RAM 112 is arranged outside the first integrated circuit 110 in the present embodiment, it is permissible to adopt a configuration in which a part or all of the functions thereof are provided in the first integrated circuit 110 or the first DSP 111.

At least a second digital signal processor (DSP) 115 and a CPU 117 are provided in the second integrated circuit 114. Although a shutter driving circuit 122, a focus driving circuit 123, and a diaphragm driving circuit 125 are further provided in the second integrated circuit 114 in the present embodiment, it is permissible to adopt a configuration in which these are provided in another integrated circuit.

The second DSP 115 is connected to the image sensor 107 via a second interface (IF) 109, which acts as a second output portion, receives image data transmitted from the image sensor 107, and executes image processing.

Examples of image processing executed by the second DSP 115 include processing for correcting LV image data, generation of display images to be displayed on a display unit 119, and the like.

A second RAM 116 is connected to the second integrated circuit 114, stores image data processed by the second DSP 115, and further functions as a working memory when the later-described CPU 117 operates.

Note that although the present embodiment adopts a configuration in which both functions are realized using RAMs, another type of memory can also be used as long as it is a memory that has a sufficiently high access speed and is problem-free in terms of operations. Also, although the second RAM 116 is arranged outside the second integrated circuit 114 in the present embodiment, it is permissible to adopt a configuration in which a part or all of the functions thereof are provided in the second integrated circuit 114, the second DSP 115, or the CPU 117.

Here, the first integrated circuit 110 and the second integrated circuit 114 are connected via a third interface (IF) 113. Still image data corrected by the first DSP 111 inside the first integrated circuit 110 is transmitted to the second integrated circuit 114 via the third IF 113, and recorded into a recording medium 120 via the second DSP 115.

The CPU 117 integrally controls the operations of the image capturing apparatus 150, and executes a program for controlling each component of the image capturing apparatus. The CPU 117 controls shooting timings of moving images and still images, which will be described later, by configuring various types of settings on the image sensor 107. Furthermore, it also has a function of adjusting a focal point of the image capturing optical system 104 by driving and controlling the later-described focus driving circuit 123 using a computation result output from the second DSP 115.

The CPU 117 is connected to an operation unit 118, a display unit 119, a recording medium 120, a ROM 121, a shutter driving circuit 122, a focus driving circuit 123, and a diaphragm driving circuit 125.

The operation unit 118 includes such operation members as buttons and levers. A user inputs an instruction to the CPU 117 and performs shooting by operating an operation member of the operation unit 118. The operation unit 118 includes a still image shooting start button. Upon detecting a user's operation of depressing the still image shooting start button, the CPU 117 performs control to shoot a still image after a certain time period has elapsed.

The display unit 119 displays images processed by the second DSP 115, menus, and the like. Not only a display, but also an electronic viewfinder (EVF) or the like, may be used as the display unit 119. The recording medium 120 is an attachable and removable recording medium in which still image data and moving image data are recorded, and can be realized by, for example, a memory card or the like. The ROM 121 stores, for example, a program intended for the CPU 117 to control the operations of each component.

The shutter driving circuit 122 drives and controls the focal plane shutter 105. The focus driving circuit 123 changes a focus position of the image capturing optical system 104. That is to say, the focus driving circuit 123 performs focus adjustment by driving and controlling the focus actuator 124 based on the output of the CPU 117, and moving the focus lenses (the second lens 102 and the third lens 103) in the optical axis direction. The diaphragm driving circuit 125 changes the aperture diameter of the diaphragm 101 by driving and controlling the diaphragm actuator 126, thereby adjusting the amount of light incident on the image sensor 107.

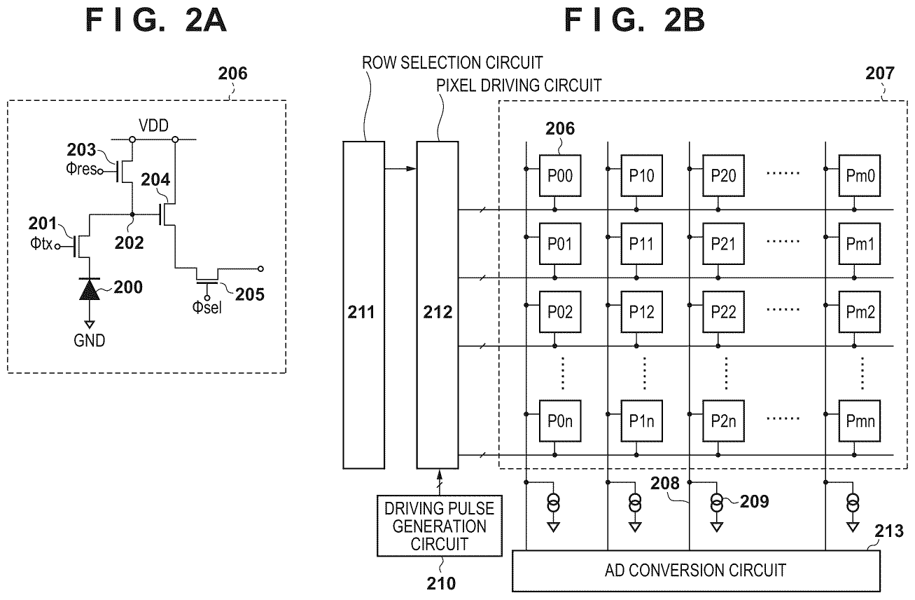

FIG. 2A is a circuit diagram of a unit pixel, and FIG. 2B is a diagram showing configurations of a pixel array and peripheral circuits. Especially, circuits around pixels in the image sensor 107 will be described with reference to FIGS. 2A and 2B.

First, a circuit configuration of a unit pixel 206 will be described with reference to FIG. 2A. A photodiode (hereinafter, PD) 200 as a photoelectric conversion unit is arranged underneath a microlens, and generates and accumulates charges corresponding to the amount of incident light. A transfer switch 201 is a switch controlled by a control signal ϕtx. Setting the value of the control signal ϕtx at high (hereinafter, H) turns the transfer switch 201 ON, and causes the charges accumulated in the PD 200 to be transferred to a floating diffusion unit (hereinafter, FD) 202.

A reset switch 203 is a switch controlled by a control signal ϕres, and resets the FD 202. Setting both of the control signals ϕtx and ϕres at H places both of the PD 200 and FD 202 under a power supply voltage (VDD); in this way, a pixel reset operation is performed.

A transistor 204, which functions also as a pixel amplifier, is connected to a select switch 205 and also to a constant current source 209 (see FIG. 2B) via a column output line 208 (see FIG. 2B). When the value of a control signal ϕsel of the select switch 205 is set at H, the transistor 204 is connected to the constant current source 209, thereby forming the pixel amplifier. The charges transferred from the PD 200 to the FD 202 are converted into a voltage value corresponding to the amount of charges by the pixel amplifier, and output to the column output line 208 as a pixel signal.

Next, an overall configuration of the image sensor 107 will be described with reference to FIG. 2B.

In a pixel array (pixel portion) 207, a plurality of unit pixels 206 are arranged in a matrix. Specifically, (m+1) unit pixels 206 and (n+1) unit pixels 206 are arranged in the horizontal direction and the vertical direction, respectively. Note that m and n are natural numbers. With this configuration, a plurality of photoelectric conversion elements are arranged in a matrix in the pixel array 207.

A driving pulse generation circuit 210 generates pulses for performing a reset operation and a readout operation for the unit pixels 206. The pulses generated by the driving pulse generation circuit 210 are supplied to a pixel driving circuit 212. A row selection circuit 211 selects a specific row to which the pulses generated by the driving pulse generation circuit 210 are to be supplied, and sets the selected specific row in the pixel driving circuit 212. The pixel driving circuit 212 supplies the pulses generated by the driving pulse generation circuit 210 to the specific row that has been selected and set by the row selection circuit 211.

The row selection circuit 211 allows readout of signals from the pixel array 207 to be performed in a plurality of methods. For example, in a case where pixel signals to be used for a still image are read out, as high-resolution image data is necessary, the row selection circuit 211 selects every row of the pixel array 207 and reads out pixel signals.

On the other hand, in a case where pixel signals to be used for LV moving images (live-view moving images) are read out, as a high resolution is not required, the row selection circuit 211 performs an operation of selecting rows of the pixel array 207 at an interval of two rows and reading out pixel signals. In this case, following the 0^{th} row, pixel signals of the 3^{rd} row are read out. Reading out pixel signals in this way makes it possible to obtain LV image data whose vertical resolution has been reduced to ⅓ of that of the still image described earlier.

Comparing the still image with the LV image, while the still image has an excellent resolution, the properties of the LV image are such that a readout time period is shortened along with a reduction in the vertical resolution, and electric power necessary for the readout can be reduced. In this way, the row selection/control mode of the row selection circuit 211 enables obtainment of a plurality of types of images that suit their respective purposes. Note that no limitation is intended by a configuration that performs readout while thinning out pixel rows; for example, it is permissible to adopt a configuration that obtains LV image data with a low vertical resolution by adding pixel signals of a plurality of pixel rows.

Pixel signals are output, on a row-by-row basis, to the column output lines 208 in accordance with the pulses supplied from the pixel driving circuit 212. The constant current source 209 constitutes a source follower circuit in combination with the transistors 204. An AD conversion circuit 213 converts analog signals output to the column output lines 208 into digital signals.

Note that although the present embodiment adopts a configuration in which pixel signals are read out from the pixel array 207 on a per-row basis, the present invention is not limited to this. For example, when two column output lines are prepared for each column, pixel signals of two rows can be simultaneously read out for both of the still image and the LV image by changing the connection between pixels and the column output lines between even-numbered rows and odd-numbered rows. By adopting such a configuration that allows pixel signals of a plurality of rows to be simultaneously read out, a readout time period can be shortened. Meanwhile, the larger the number of column output lines, the more the complexity of circuits. Therefore, it is desirable to determine an appropriate number of column output lines in accordance with the method of use.

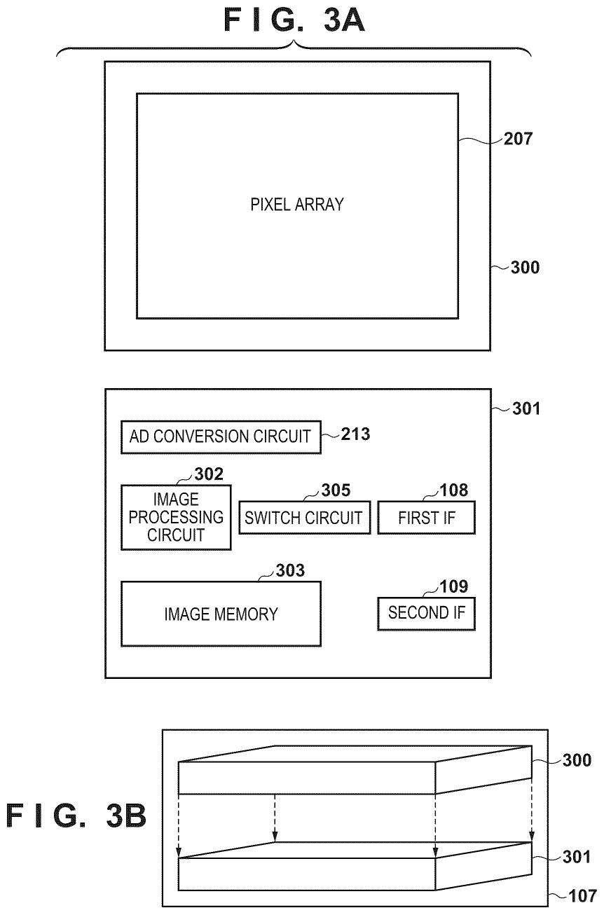

FIGS. 3A and 3B are diagrams showing a configuration of an image sensor composed of a plurality of semiconductor substrates. A configuration of the image sensor 107 according to the present embodiment will be described with reference to FIGS. 3A and 3B.

In general, as a method of configuring an image sensor, a method is known that configures a single image sensor by providing a plurality of semiconductor substrates with separate circuits, stacking these plurality of semiconductor substrates on each other, and connecting them to each other. In the image sensor 107 according to the present embodiment as well, a single image sensor chip is configured by stacking a first semiconductor substrate 300 and a second semiconductor substrate 301 on each other.

Configurations of circuits that are respectively mounted on the first semiconductor substrate 300 and the second semiconductor substrate 301 will be described with reference to FIG. 3A.

The pixel array 207 is provided on the first semiconductor substrate 300. Also, an AD conversion circuit 213, an image processing circuit 302, an image memory 303, a switch circuit 305, a first IF 108, and a second IF 109 are provided on the second semiconductor substrate 301.

The image processing circuit 302 is information processing means for processing information that has been read out from the pixel array 207, thereby converting this information into another type of information. While the image processing circuit 302 can execute various types of processing, it is assumed in the present embodiment that it converts a still image into an LV image by reducing the still image.

The image memory 303 is a memory that temporarily stores pixel data that has been read out from the pixel array 207 and converted into digital values in the AD conversion circuit 213, and image data processed by the image processing circuit 302. In the present embodiment, any memory may be used as this memory as long as it is configured to be capable of storing data and allowing data that has been stored to be read out sufficiently faster than the speed of readout of pixel signals from the pixel array 207 and the processing speed in the image processing circuit 302.

The first IF 108 is connected to the AD conversion circuit 213, and outputs image data that has been read out to the outside without storing the same into the image memory 303. The second IF 109 is connected to the image memory 303, and outputs image data that has been stored into the image memory 303 to the outside.

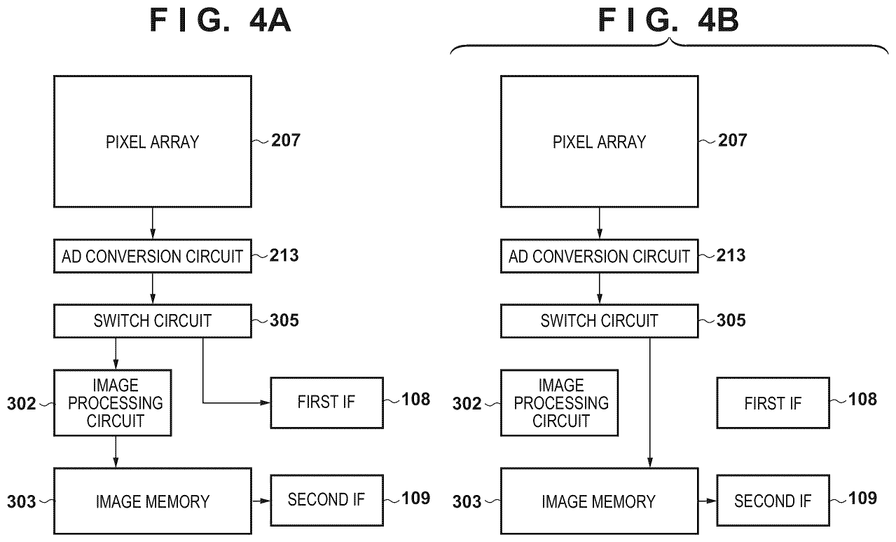

The switch circuit 305 is controlled by the CPU 117, and has a function of switching the output destination of image data output from the AD conversion circuit 213 to one of the image processing circuit 302, image memory 303, and first IF 108. This switching will be described later with reference to FIGS. 4A and 4B.

Note that circuits other than the illustrated circuits may be arranged between the discrete blocks. For example, it is also permissible to adopt a configuration in which a correction processing circuit that executes correction processing with respect to images that have been read out from the AD conversion circuit 213 is arranged between the AD conversion circuit 213 and the first IF 108, or between the AD conversion circuit 213 and the image processing circuit 302.

FIG. 3B is a schematic diagram showing an example in which the first semiconductor substrate 300 and the second semiconductor substrate 301 are stacked to configure the image sensor 107, which is a single chip. The figure shows a state where the first semiconductor substrate 300 is stacked on the second semiconductor substrate 301. Any known technique may be used as a technique to electrically connect the stacked semiconductor substrates to each other.

Note that although the present embodiment presents a configuration in which the pixel array 207 is mounted on the first semiconductor substrate 300 and all other circuit blocks are mounted on the second semiconductor substrate 301, the present invention is not limited to this. For example, it is permissible to adopt a configuration in which all of the pixel array and circuit blocks are mounted on the same semiconductor substrate, or a configuration in which the circuit blocks are further mounted on a plurality of semiconductor substrates.

FIGS. 4A and 4B are diagrams schematically showing the paths of image data pieces of still images, reduces still images, and LV images. With reference to FIGS. 4A and 4B, the following describes what kind of circuit blocks (data path) each of image data pieces of still images, reduced still images, and LV images passes through when output to the outside of the image sensor 107.

FIG. 4A is a data path diagram illustrating a data path that still images and reduced still images pass through.

Pixel signals of a still image are read out from the pixel array 207, and converted into digital values in the AD conversion circuit 213. Thereafter, this image data reaches a bifurcation between a path via which the image data is output from the first IF 108 as is, and a path via which the image data is input to the image processing circuit 302. These paths are set by the switch circuit 305 in accordance with an instruction from the CPU 117. The image processing circuit 302 executes processing for reducing the image data input to the image processing circuit 302 from the still image into a reduced still image. Thereafter, the image data is output from the second IF 109 via the image memory 303.

The reduced still image can have various resolutions. For example, by reducing the resolution to the same resolution as LV images in the image processing circuit 302, the second DSP 115 in a later stage can execute the same processing for the reduced still image and the LV images. Note that regarding the resolution of the reduced still image, it may be a resolution equal to or higher than the resolution of the LV images as a result of reduction processing, or may be a resolution lower than the resolution of the LV images as a result of reduction processing.

Furthermore, it is also possible that only the resolution in the horizontal direction is lowered to the resolution of the LV images in the image processing circuit 302, and then the reduced still image is transmitted. In this case, although the second DSP 115 needs to execute reduction processing in the vertical direction, the circuit scale of the image processing circuit 302 can be reduced.

FIG. 4B is a data path diagram illustrating a data path via which LV images pass through. Pixel signals of an LV image output from the pixel array 207 are converted into digital values by the AD conversion circuit 213, and accumulated in the image memory 303. Thereafter, the pixel signals are output from the second IF 109. This path is set by the switch circuit 305 in accordance with an instruction from the CPU 117.

As described above, when data paths are configured as shown in FIGS. 4A and 4B, high-resolution data that has been read out as a still image is output from the first IF 108, and low-resolution data that has been read out as a reduced still image or an LV image is output from the second IF 109. Then, the still image is output to the first DSP 111, and the reduced still image and the LV image are output to the second DSP 115. By executing processing using different DSPs for different types of data in the foregoing manner, data processing for still images and data processing for LV display can be executed completely in parallel.

In general, when transmitting high-resolution data, the transmission takes time. Also, it is difficult to share still images with LV display as they differ from LV images in resolution and the like. For this reason, in a case where still images and LV images are transmitted using the same IF and data processing is executed by the same DSP, there is a problem of difficulty in performing an update always at constant timings without thinning out LV display. To address this problem, the configuration of the present embodiment allows an update to be performed always at constant timings without thinning out LV display.

Furthermore, as the first IF 108 is required to transmit image data at a communication speed equal to or higher than the speed of readout of still images, a high-speed interface needs to be prepared thereas. In contrast, the second IF 109 that transmits image data for LV display does not require such a high-speed interface. It is sufficient that the second IF 109 transmits image data at a speed necessary for display on the display unit 119. That is to say, as an interface that is lower in speed than the first IF 108 can be used as the second IF 109, the cost of the image sensor can be reduced. In this case, a configuration is adopted in which a reduced still image and an LV image are stored into the image memory 303 to make the transmission speed of the second IF 109 slower than the readout speed.

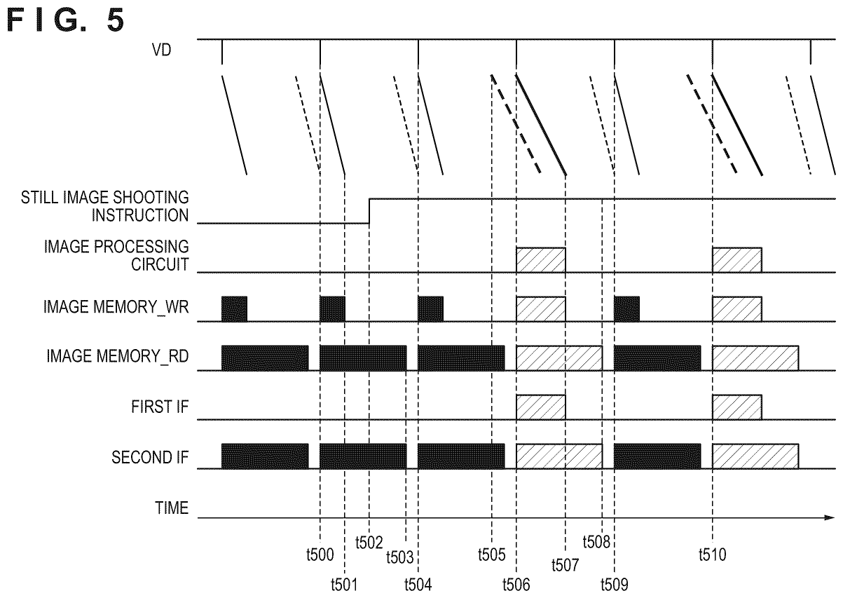

FIG. 5 is a timing chart showing the operations of the image sensor according to the first embodiment. With reference to FIG. 5, the following describes a shooting operation and a reduction operation for still images and a shooting operation for LV images in the first embodiment.

In general, a cycle required to update LV display is different from a shooting cycle required in continuous shooting of still images. The present embodiment will be described in relation to an example in which the duration of the shooting cycle required in continuous shooting of still images is double the cycle required to update LV display. Among diagonal lines in the figure, thin dash lines indicate scanning for resetting an LV image in each unit pixel 206 included in the pixel array 207, and thin solid lines indicate scanning for reading out an LV image from the pixel array 207. Furthermore, thick dash lines indicate scanning for resetting a still image in each unit pixel 206 included in the pixel array 207, and thick solid lines indicate scanning for reading out a still image from the pixel array 207.

When a vertical synchronization signal (hereinafter, VD) is input to the image sensor 107 at time t500, the image sensor 107 reads out an LV image. Also, along with the start of the readout, writing of the LV image to the image memory 303 is started. Furthermore, the LV image is read out from the image memory 303, and outputting of data of the LV image from the second IF 109 to the second DSP 115 is started. The second DSP 115 starts processing for displaying the received image data on the display unit 119. When the readout of the LV image is completed at time t501, writing to the image memory 303 is also stopped.

When a still image shooting instruction is issued at time t502, the CPU 117 controls the image sensor 107 to start to accumulate a still image at the next VD timing or a later timing. At time t503, readout of the LV image from the image memory 303 is completed, and transmission of the image data by the second IF 109 is also completed. At this or a later timing, the second DSP 115 completes image display.

When a VD is input to the image sensor 107 at time t504, the image sensor 107 reads out an LV image again. By repeatedly inputting a VD to the image sensor 107 in the foregoing manner, an LV image can be obtained repeatedly. A time interval from time t500 to time t504 is regarded as one cycle, and inputting of a VD is repeated while preserving this predetermined cycle; as a result, LV images can be obtained in a constant cycle. By displaying the LV images that have been obtained in the predetermined cycle in the foregoing manner on the display unit 119, moving images in which a screen is updated in the predetermined cycle can be provided to a user as LV display.

At time t505, the accumulation of a still image is started. When a VD is input to the image sensor 107 at time t506, which follows an elapse of one cycle, i.e., the aforementioned predetermined cycle, since time t504, the image sensor 107 reads out a still image. Along with the start of the readout, the still image is input to the image processing circuit 302, and at the same time, outputting of data from the first IF 108 to the first DSP 111 is started. The first DSP 111 starts processing for recording the received image data as the still image. After the image processing circuit 302 has applied reduction processing to the image data input to the image processing circuit 302, writing of the image data to the image memory 303 is started, and at the same time, outputting of the image data from the second IF 109 to the second DSP 115 is started. The second DSP 115 starts processing for displaying the received image data on the display unit 119.

When the readout of the still image is completed at time t507, inputting of the image data to the image processing circuit 302 is also stopped, and writing from the image processing circuit 302 to the image memory 303 is stopped as well. Furthermore, at the same time, outputting of the image data from the first IF 108 to the first DSP 111 is also stopped. At this or a later timing, the first DSP 111 completes processing for the still image.

At time t508, outputting of the image data written to the image memory 303 is completed, and transmission of the image data from the second IF 109 is also completed. At this or a later timing, the second DSP 115 completes image display. By performing control in the foregoing manner, even in a case where a still image has been obtained, the cyclic update of LV display can be provided without interruption.

The present embodiment is under the assumption that the duration of the shooting cycle required in continuous shooting of still images is double the cycle required to update LV display. Therefore, even in a case where the still image shooting instruction (continuous shooting instruction) is ongoing from time t506 to time t509, an LV image is read out for the next frame.

When a VD is input to the image sensor 107 at time t509, the image sensor 107 reads out an LV image. When a VD is input to the image sensor 117 at time t510 that still follows, the image sensor 107 reads out a still image. At time t510 onward, the operations of times t506 to t510 are repeated.

Note that although the timing chart of FIG. 5 has been described in relation to a case where a still image and an LV image are obtained alternately, the present invention is not limited to this. For example, it is permissible to adopt a configuration in which three LV images are obtained between obtainments of still images. In this case, the cycle of obtainment of an LV image may be the same as or different from before the start of the shooting instruction.

As described above, according to the first embodiment, in a configuration capable of shooting still images and LV images, the still images can be further output as reduced still images. Furthermore, it is possible to receive a still image in the first DSP 111 and apply correction processing for still images thereto, and in parallel with this, receive a reduced still image and an LV image in the second DSP 115 and apply correction processing for LV display images thereto. As a result, the display unit 119 can be provided with a cyclic update of display images without thinning, and shooting and correction processing for still images can be executed in parallel. Furthermore, an increase in the circuit scale of the second IF 109 can be suppressed in such a configuration as well.

### Modification Example

Although it is assumed in the first embodiment that the image processing circuit 302 reduces still images, the present invention is not limited to this. The image processing circuit 302 may execute another processing. Development for LV display may be performed first based on at least one of LV image data and reduced still image data, and then luminance information of each color may be calculated. Also, subject detection information may be calculated for a subject tracking function based on at least one of LV image data and reduced still image data.

Furthermore, photometric computation may be performed for an automatic exposure adjustment function based on at least one of LV image data and reduced still image data. In addition, flicker detection information may be calculated for a flicker-free shooting function based on at least one of LV image data and reduced still image data.

Also, phase difference information may be calculated for an autofocus adjustment function based on at least one of LV image data and reduced still image data. Other various calculations are possible. Furthermore, in a case where these various calculations are performed, the image processing circuit 302 can perform the calculations also with respect to images obtained as LV images.

By thus calculating various types of information in the image processing circuit 302, the configuration of the second DSP 115 can be simplified and made more versatile.

### Second Embodiment

A second embodiment will be described in relation to a case where the shooting frame rate of still images in continuous shooting is higher than the frame rate of LV display. In this case, while a still image shooting instruction is ongoing, LV images are not obtained, and LV display is performed entirely based on reduced still images generated from still images.

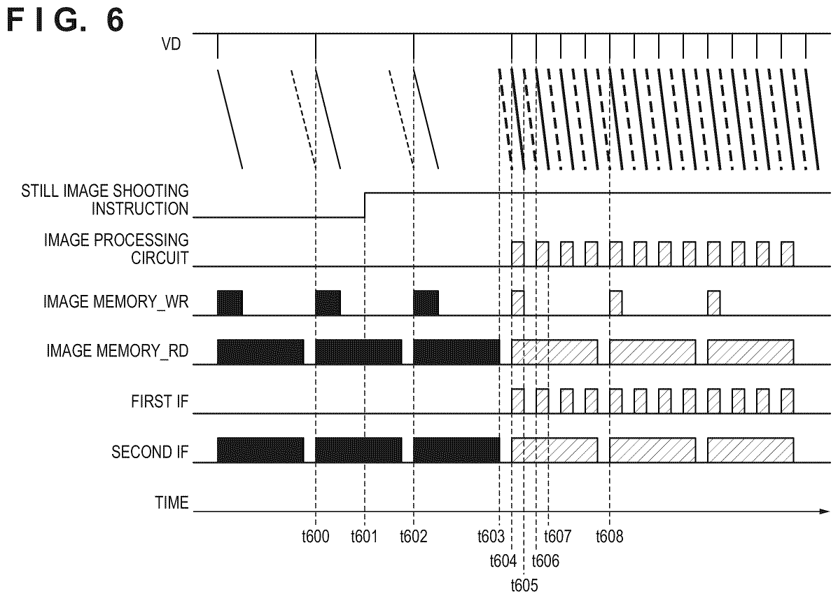

FIG. 6 is a timing chart showing the operations of the image sensor according to the second embodiment. With reference to FIG. 6, the following describes a shooting operation and a reduction operation for still images in the second embodiment.

As has already been described, in general, a cycle required to update LV display is different from a shooting cycle required in continuous shooting of still images. The present embodiment will be described in relation to an example in which the duration of the cycle required in continuous shooting of still images is ¼ of the cycle required to update LV display. Among diagonal lines in the figure, thin dash lines indicate scanning for resetting an LV image in each unit pixel 206 included in the pixel array 207, and thin solid lines indicate scanning for reading out an LV image from the pixel array 207. Furthermore, thick dash lines indicate scanning for resetting a still image in each unit pixel 206 included in the pixel array 207, and thick solid lines indicate scanning for reading out a still image from the pixel array 207. Also, the description of portions that perform operations similarly to the timing chart of FIG. 5 is omitted.

Note that the timing chart of FIG. 6 indicates a configuration in which the speed of readout of a still image is faster than the speed of readout of an LV image. This can be realized by enabling the installation of additional column output lines for improving the readout speed, which are illustrated in FIGS. 2A and 2B, only in a still image mode. Note that the speed of readout of a still image need not necessarily be faster than the speed of readout of an LV image, and it is sufficient that a readout time period of a still image be shorter than the duration that is ¼ of the cycle required to update LV display.

When a vertical synchronization signal (VD) is input to the image sensor 107 at time t600, the image sensor 107 reads out an LV image, and also starts to update display of the display unit 119 at the same time. When a still image shooting instruction is issued at time t601, a preparation for starting still image shooting is started. When a vertical synchronization signal (VD) is input to the image sensor 107 at time t602, the image sensor 107 reads out an LV image, and also starts to update display of the display unit 119 at the same time. A time interval from time t600 to time t602 (an image obtainment cycle) has been set to match the update cycle of LV display that is presented on the display unit 119.

At time t603, the image sensor 107 starts to accumulate a still image. When a vertical synchronization signal (VD) is input to the image sensor 107 at time t604, the image sensor 107 reads out a still image. Along with the start of the readout of the still image, the still image is input to the image processing circuit 302, and at the same time, outputting of image data from the first IF 108 to the first DSP 111 is started.

The first DSP 111 starts processing for recording the received image data as the still image. After the image processing circuit 302 has applied reduction processing to the image data input to the image processing circuit 302, writing of the image data to the image memory 303 is started, and at the same time, outputting of the data from the second IF 109 to the second DSP 115 is started. The second DSP 115 starts processing for displaying the received image data on the display unit 119.

When the readout of the still image is completed at time t605, inputting of the image data to the image processing circuit 302 is also stopped, and writing from the image processing circuit 302 to the image memory 303 is stopped as well. Also, at the same time, outputting of the image data from the first IF 108 to the first DSP 111 is also stopped. At this or a later timing, the first DSP 111 completes processing for the still image. Furthermore, at the same time t605, accumulation for the next still image is also started.

Time t606 is the time at which a time period equivalent to ¼ of the update cycle of LV display has elapsed since time t604. When a vertical synchronization signal (VD) is input to the image sensor 107 at time t606, the image sensor 107 reads out a still image. Along with the start of the readout of the still image, outputting of image data from the first IF 108 to the first DSP 111 is started. The first DSP 111 starts processing for recording the received image data as the still image.

Meanwhile, at this timing, the still image is not input to the image processing circuit 302. At this time, the reduced still image that finished being stored at time t605 is continuously read out from the image memory 303. When the readout of the still image is completed at time t607, outputting of image data from the first IF 108 to the first DSP 111 is also stopped. By controlling the image sensor 107 in the foregoing manner, processing that does not display a still image even when the still image has been shot can be executed.

Time t608 is the time at which a time period equivalent to the update cycle of LV display has elapsed since time t604. Therefore, a still image that is read out as a result of inputting of a vertical synchronization signal (VD) to the image sensor 107 at time t608 is input to the image processing circuit 302, and a reduced still image is generated therefor and used for display. Other processing is similar to processing for the still image that was read out at time t604.

Here, between time t604 and time t608, four images are read out, including the images that were read out from time t606 to time t608. The cycle of readout of still images therebetween is equal to ¼ of the update cycle of LV display.

Note that although the cycle of obtainment of still images is ¼ of the update cycle of LV display in the present embodiment, the present invention is not limited to this. Also, in order to maintain the update cycle of LV display constant, it is sufficient to configure a setting so that an integral multiple of the cycle of obtainment of still images matches one update cycle of LV display.

For example, in a case where the update cycle of LV display is 60 fps, the update cycle of LV display can be maintained at 60 fps by setting the cycle of obtainment of still images at 120 fps or 180 fps. In a case where the cycle of obtainment of still images is set at, for example, 100 fps while the update cycle of LV display is 60 fps, there may be a case where a still image is not read out at a timing when an image for LV display is to be obtained. This prevents the update cycle of LV display from being maintained constant before and after a still image shooting instruction.

As described above, according to the second embodiment, the cycle of obtainment of still images can be set at a cycle shorter than the cycle of LV display while maintaining the cycle of LV display constant.

### Third Embodiment

A third embodiment will be described in relation to a case where images that are used neither as still images nor for LV display are obtained while displaying LV images. In a camera system, there are cases where images that are not presented to a user are obtained to, for example, use information in flicker detection and the like. Herein, such images are referred to as sub-scanning images, and scanning of the image sensor for obtaining the sub-scanning images is referred to as sub-scanning. The following describes a method of use of pixels, a path of image data, and a timing chart of image capture in relation to sub-scanning images.

According to the description of FIG. 2B, the row selection circuit 211 performs an operation of selecting and reading out the pixel array 207 on a per-row basis at an interval of two rows at the time of obtainment of LV images that are not required to have a high resolution. In this case, unused pixels exist in the pixel array 207. In view of this, for example, during sub-scanning, an operation of selecting and reading out such unused pixels on a per-row basis at an interval of eight rows is performed. In this way, pixels different from pixels for LV are used for sub-scanning images; accordingly, accumulation for sub-scanning can be performed independently of accumulation of LV images.

Furthermore, accumulation for sub-scanning can also be performed in parallel with readout of LV images by newly preparing column output lines for sub-scanning and connecting pixels to the column output lines for sub-scanning at the time of sub-scanning. Note, in the present embodiment, it is assumed that such a configuration is not adopted, and timings of readout of LV images and timings of readout of sub-scanning images are in an exclusive relationship.

A path diagram of data of sub-scanning images is exactly the same as the path diagram of LV images in FIG. 4B, and thus a description thereof is omitted. Signals of a sub-scanning image output from the pixel array 207 are converted into digital values by the AD conversion circuit 213, and accumulated in the image memory 303. Thereafter, the signals are output from the second IF 109.

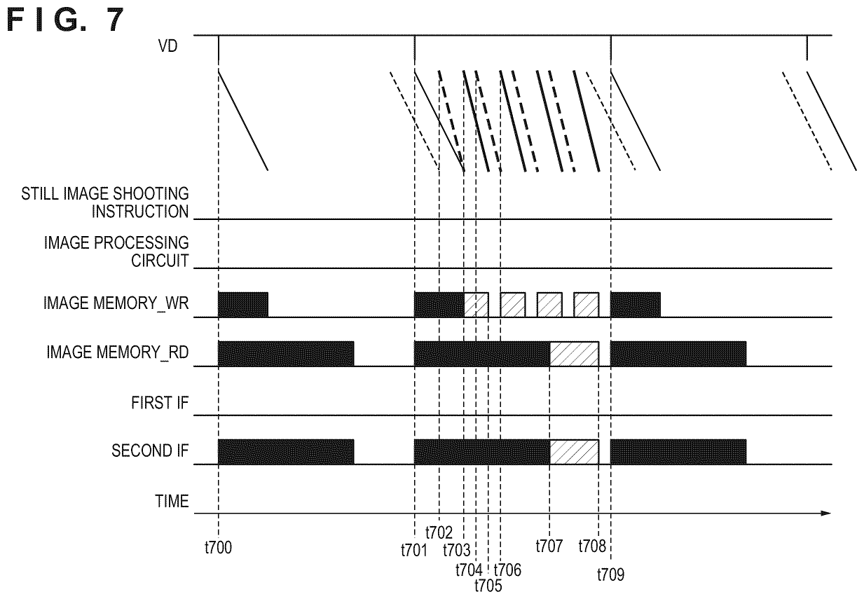

FIG. 7 is a timing chart showing the operations of the image sensor according to the third embodiment. With reference to FIG. 7, the following describes a shooting operation for LV images and a shooting operation for sub-scanning images in the third embodiment. Among diagonal lines in the figure, thin dash lines indicate scanning for resetting an LV image in each unit pixel 206 included in the pixel array 207, and thin solid lines indicate scanning for reading out an LV image from the pixel array 207. Furthermore, thick dash lines indicate scanning for resetting a sub-scanning image in each unit pixel 206 included in the pixel array 207, and thick solid lines indicate scanning for reading out a sub-scanning image from the pixel array 207.

When a vertical synchronization signal (VD) is input to the image sensor 107 at time t700, the image sensor 107 reads out an LV image. Also, along with the start of the readout, writing of the LV image to the image memory 303 is started. Furthermore, the LV image is read out from the image memory 303, and outputting of data from the second IF 109 to the second DSP 115 is started. The second DSP 115 starts processing for displaying the received data on the display unit 119.

When a vertical synchronization signal (VD) is input to the image sensor 107 again at time t701, the image sensor 107 reads out an LV image again. This time interval from time t700 to time t701 is the update cycle of LV display.

At time t702, accumulation of a sub-scanning image is started. At time t703, readout of the LV image is completed, and at the same time, readout of the sub-scanning image is started. Also, along with the start of the readout of the sub-scanning image, writing of the sub-scanning image to the image memory 303 is started. At this time, the LV image is read out from the image memory 303 and output from the second IF 109. Therefore, at this timing, the sub-scanning image is not read out from the image memory 303.

At time t704, accumulation of the next sub-scanning image is started. At time t705, readout of the sub-scanning image is completed, and writing to the image memory 303 is also completed. At this time, too, the sub-scanning image is not read out from the image memory 303.

At time t706, readout of the sub-scanning image is started again. In this way, the sub-scanning image is read out and written to the image memory 303 during a blanking period in which an LV image is obtained. Thereafter, at time t707, readout of the LV image from the image memory 303 is completed. At the same time, readout of the sub-scanning image from the image memory 303 is started. At time t708, the readout of the sub-scanning image from the image memory 303 is completed.

When a vertical synchronization signal (VD) is input to the image sensor 107 at time t709, the image sensor 107 reads out an LV image. In this frame, a sub-scanning image is not read out.

As described above, according to the third embodiment, sub-scanning images that are not provided to a user as images can be read out while obtaining LV images in a constant cycle. Note that although the present embodiment has presented a method in which sub-scanning images are not processed by the image processing circuit 302, various types of data may be obtained by processing sub-scanning images in the image processing circuit, similarly to the case of LV images according to the modification example of the first embodiment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-203122, filed Nov. 30, 2023, which is hereby incorporated by reference herein in its entirety.

What is claimed is:

1. An image capturing apparatus, comprising:
an image sensor including
a pixel portion in which a plurality of pixels are arrayed in a matrix,
a readout portion configured to read out a first image signal and a second image signal from the pixel portion, the second image signal being lower in resolution than the first image signal,
an image processor configured to generate a third image signal from the first image signal, the third image signal being lower in resolution than the first image signal,
a first output portion configured to output the first image signal, and
a second output portion configured to output the second image signal or the third image signal;
a first integrated circuit configured to process the first image signal output from the first output portion of the image sensor; and
a second integrated circuit configured to process the second image signal or the third image signal output from the second output portion of the image sensor.

2. The image capturing apparatus according to claim 1, wherein
the second image signal or the third image signal is used in live-view display.

3. The image capturing apparatus according to claim 1, wherein
a resolution of the third image signal is lower than a resolution of the first image signal, and is equal to or higher than a resolution of the second image signal.

4. The image capturing apparatus according to claim 3, wherein
the resolution of the third image signal is equal to the resolution of the second image signal.

5. The image capturing apparatus according to claim 1, wherein
a resolution of the third image signal is lower than a resolution of the second image signal.

6. The image capturing apparatus according to claim 1, further comprising
a switching device configured to switch between a first state where the first image signal is output from the first output portion and the third image signal is output from the second output portion, and a second state where the second image signal is output from the second output portion.

7. The image capturing apparatus according to claim 6, further comprising
a display device configured to display an image, the display device displaying an image based on the second image signal before a user issues a shooting instruction, and displaying an image based on the third image signal after the user has issued the shooting instruction.

8. The image capturing apparatus according to claim 1, wherein
a communication speed at which a signal is output from the first output portion is faster than a communication speed at which a signal is output from the second output portion.

9. The image capturing apparatus according to claim 1, further comprising
a storage device arranged between the image processor and the second output portion.

10. The image capturing apparatus according to claim 1, further comprising
a transmission device configured to transmit a signal processed by the first integrated circuit to the second integrated circuit.

11. The image capturing apparatus according to claim 1, wherein
the image processor calculates luminance information of an image using at least one of the second image signal and the third image signal.

12. The image capturing apparatus according to claim 1, wherein
the image processor detects a subject using at least one of the second image signal and the third image signal.

13. The image capturing apparatus according to claim 1, wherein
the image processor detects photometric information using at least one of the second image signal and the third image signal.

14. The image capturing apparatus according to claim 1, wherein
the image processor detects flicker using at least one of the second image signal and the third image signal.

15. The image capturing apparatus according to claim 1, wherein
the image processor detects phase difference information using at least one of the second image signal and the third image signal.
